(19) United States
(12) Patent Application Publication
(10) Pub. No.: US 2016/0098260 A1
(43) Pub. Date: Apr. 7, 2016

(54) SINGLE GESTURE ACCESS TO AN OPERATING SYSTEM MENU TO INITIATE OPERATIONS RELATED TO A CURRENTLY EXECUTING APPLICATION

(71) Applicant: International Business Machines Corporation, Armonk, NY (US)

(72) Inventors: Yoav Bodor, Tel Aviv (IL); Ishai Borovoy, Huzot Shefayim (IL); Yaron Goldberg, Ra'ananna (IL); Itay Hindy, Tel Aviv (IL); Gal Shachor, Yokneam (IL); Arie Shifer, Ra'ananna (IL); Artem Spector, Rishon Le-Zion (IL); Issahar Weiss, Givat Shmuel (IL); Daniel M. Yellin, Ra'ananna (IL)

(21) Appl. No.: 14/507,316

(22) Filed: Oct. 6, 2014

(51) Int. Cl. G06F 9/445; G06F 3/0482; H04L 29/08; G06F 3/0488

(52) U.S. Cl. CPC G06F 8/62; G06F 3/0488; G06F 3/0482; H04L 67/10

(57) ABSTRACT

A processing system can detect a single user gesture while a first application is currently executing in a software environment provided by an operating system and has focus in the operating system. Responsive to the single user gesture being detected, an operating system menu including at least a first menu item can be presented by a user interface. The first menu item can be configured to initiate uninstallation of the first application currently executing in the software environment provided by the operating system and having focus in the operating system. Responsive to receiving a user selection of the first menu item, using a processor of the processing system, the first application currently executing in the software environment provided by the operating system and having focus in the operating system can be uninstalled.

### BACKGROUND

The present invention relates to application management on a processing system.

The use of smart phones and tablet computers has proliferated in recent years. A key feature provided by these mobile devices is the ability to interface with online stores. From the online stores, users can download and install various applications which enhance functionality of their mobile devices. The applications typically are relatively inexpensive and, sometimes, are provided free of charge.

### SUMMARY

A method includes detecting, by a processing system, a single user gesture while a first application is currently executing in a software environment provided by an operating system and has focus in the operating system. The method also includes, responsive to detecting the single user gesture, presenting by a user interface an operating system menu including at least a first menu item, the first menu item configured to initiate uninstallation of the first application currently executing in the software environment provided by the operating system and having focus in the operating system. The method further includes, responsive to receiving a user selection of the first menu item, uninstalling, using a processor of the processing system, the first application currently executing in the software environment provided by the operating system and having focus in the operating system.

A system includes a processor programmed to initiate executable operations. The executable operations include detecting a single user gesture while a first application is currently executing in a software environment provided by an operating system and has focus in the operating system. The executable operations also include, responsive to detecting the single user gesture, presenting by a user interface an operating system menu including at least a first menu item, the first menu item configured to initiate uninstallation of the first application currently executing in the software environment provided by the operating system and having focus in the operating system. The executable operations further include, responsive to receiving a user selection of the first menu item, uninstalling the first application currently executing in the software environment provided by the operating system and having focus in the operating system.

A computer program includes a computer readable storage medium having program code stored thereon. The program code is executable by a processor to perform a method. The method includes detecting, by the processor, a single user gesture while a first application is currently executing in a software environment provided by an operating system and has focus in the operating system. The method also includes, responsive to detecting the single user gesture, presenting by a user interface an operating system menu including at least a first menu item, the first menu item configured to initiate uninstallation of the first application currently executing in the software environment provided by the operating system and having focus in the operating system. The method further includes, responsive to receiving a user selection of the first menu item, uninstalling, by the processor, the first application currently executing in the software environment provided by the operating system and having focus in the operating system.

### BRIEF DESCRIPTION OF THE SEVERAL VIEWS OF THE DRAWINGS

FIG. 1 is a view of an example of a processing system.

FIG. 2 is another view of the processing system of FIG. 1.

FIG. 3 is an example of an operating system menu presented by the processing system of FIG. 1.

FIG. 4 is a block diagram illustrating example architecture for the processing system of FIG. 1.

FIG. 5 is a flow chart illustrating an example of a method of uninstalling an application currently executing on a processing system.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to application management on a processing system. The processing system can detect single user gesture while a first application is currently executing in a software environment provided by an operating system and has focus in the operating system. Responsive to the single user gesture, an operating system menu (OS menu) can be presented. From the OS menu, the user can select a menu item related to the application. In illustration, the user can select the menu item to initiate operations related to management of the application or to perform online store operations related to the application. The application management operations can include, for example, uninstallation of the application, clearing data related to the application, presenting details related to the application's use of data storage and presenting information related to the permissions assigned to the application. The online store operations can include, for example, finding other applications related to the currently executing application and initiating creation of an electronic message via which the user may send feedback related to the currently executing application.

Notably, any of the above operations can be implemented without requiring the user to directly interact with the currently executing application. Instead, the user can directly interact with the operating system. For example, in response to the user selecting a menu item to uninstall the currently executing application, the operating system can automatically terminate execution of, and uninstall, the application. Accordingly, the arrangements described herein simplify use of the processing system. In this regard, uninstalling applications, as well as initiating other processes, typically is cumbersome. User's oftentimes must navigate multiple different menus to find a particular process the user desires to implement. This can lead to user frustration when using a processing system.

Moreover, online stores oftentimes provide a number of different applications that are intended to provide the same basic functionality. Some applications, however, may be more user friendly than others, or may provide certain desirable features not provided by the other applications. Hence, users sometimes install multiple applications before deciding which application the user wants to keep. Sometimes, the user then goes through a relatively complicated process of uninstalling unwanted applications to reduce the amount of device resources (e.g., storage) being used. The arrangements described herein, however, greatly simplify this process. If a user has an application open that the user chooses not to keep, rather than having to close the application and then navigate multiple menus to uninstall the application, with a single gesture the user can access an OS menu. From that OS menu, the user can select a single menu item to uninstall the unwanted application.

Several definitions that apply throughout this document now will be presented.

As defined herein, the term “application” means a program, or group of programs, that is designed for use by an end user. An application executes in a software layer above a system software layer in which an operating system executes. In this regard, an application executes in a software environment provided by the operating system

As defined herein, the term “operating system” means software that supports a processing system's basic functions, such as scheduling tasks, executing applications and controlling peripherals. In the context of the arrangements described herein, an “operating system” is not an application.

As defined herein, the term “operating system menu” means a menu generated by an operating system. An operating system menu may identify one or more applications executing in the software environment provided by the operating system, but is not generated by such applications.

As defined herein, the term “OS” is an acronym for the term “operating system.” Accordingly, the term “OS menu” means “operating system menu.”

As defined herein, the term “menu item” means an item presented in a menu that is user selectable. A menu item may be selected by a user using a user gesture.

As defined herein, the term “user gesture” means a gesture of a user detected as a user input. Examples of a user gesture include, but are not limited to, a touch, a tap, depressing a button, movement of one or more appendages (e.g., finger(s)), and the like.

As defined herein, the term “single user gesture” means one, and only one, user gesture. In the context of the arrangements described herein, two or more user gestures, for example sequential user gestures, are not a “single user gesture.”

As defined herein, the term “uninstall” means to remove an application from a processing system.

As defined herein, the term “online store” means a digital distribution platform that allows users to browse and download applications via the Internet.

As defined herein, the term “focus” means a center of interest or activity. For example, an application has focus when the application is selected by a user, when the application is the only application with which a user interacts that is open in a software environment provided by an operating system, or when the application is the most recent application with which the user has interacted from among a plurality of applications open in a software environment provided by an operating system.

As defined herein, the term “processing system” means a device or system including at least one processor configured to execute program code. Examples of a processing system include, but are not limited to, a computer, a workstation, a desktop computer, a laptop computer, a netbook computer, a tablet computer, a smart phone, a digital personal assistant, a gaming console, a set top box, and the like.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “buffer” means is a region of a physical memory used to temporarily store data.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “automatically” means without user intervention.

As defined herein, the term “user” means a person (i.e., a human being).

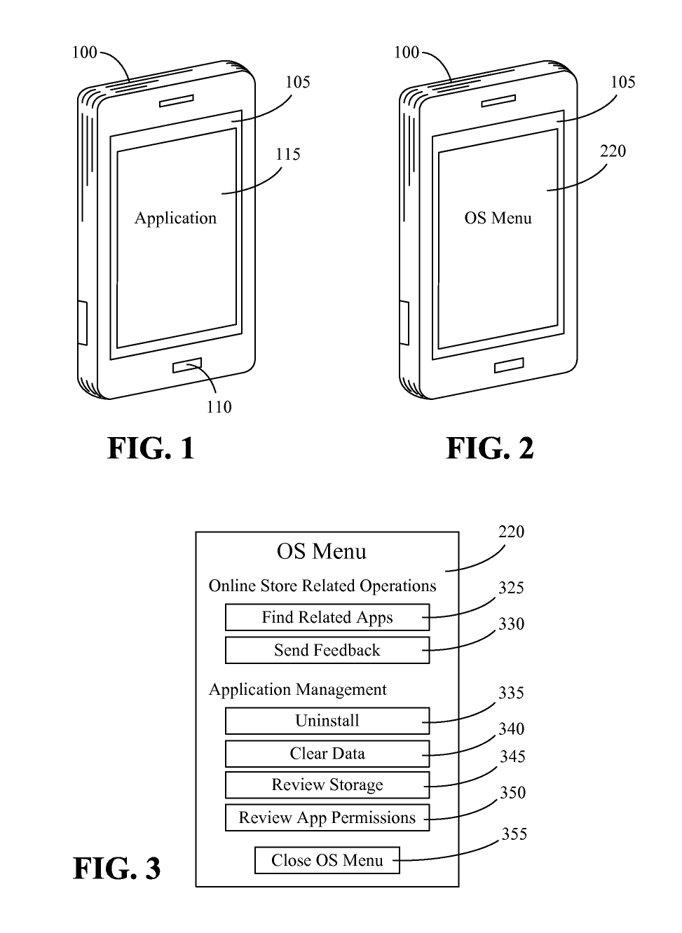

FIG. 1 is a view of an example of a processing system 100. The processing system 100 can include a display 105 or otherwise can be communicatively linked to a display. In one arrangement, the display 105 can be a touchscreen, though the present arrangements are not limited in this regard. In the case that the display 105 is a touchscreen, the display 105 can be configured to detect user gestures. For example, the display 105 can include capacitive touch sensors, resistive touch sensors, or any other suitable touch sensors. The display 105 can detect user touches, user taps, movement of one or more fingers (e.g., swipes) across the display 105, pinch gestures, and the like. In one aspect, the display 105 also can be configured to detect user gestures proximate to, but not actually touching, the display. For instance, the display 105 can detect movement of one or more fingers above the display 105. In other arrangements, processing system 100 can include one or more gesture sensors (not shown), for example infrared sensors, image sensors (e.g., cameras), or the like configured to detect movement of one or more fingers above the display 105, or elsewhere proximate to the processing system 100.

The processing system 100 also can include one or more buttons 110, keys, soft keys, and/or the like configured to detect user gestures, for example touches, taps or presses by a user. In one arrangement, the processing system 100 can include, or be communicatively linked to, a keyboard, keypad, touchpad, trackpad, mouse, and/or other user input device configured to detect user gestures, for example a click of a key, a press of a mouse button, a touch, a tap, etc. Still, the processing system 100 can be configured to detect user gestures in any other suitable manner and the present arrangements are not limited in this regard.

In operation, an application 115 can be executed on the processing system 100. For instance, an operating system can be executing on the processing system 100, and the application 115 can be currently executing in a software environment provided by the operating system. While the application 115 is currently executing, and has focus in the software environment provided by the operating system of the processing system 100, the user can provide a user gesture detected by the processing system 100. The user gesture can be detected, for example, by the operating system. Responsive to detecting the single user gesture, the processing system 100 can present an operating system menu (OS menu) 220 on the display 105, for example as shown in FIG. 2. In illustration, the OS menu 220 can be presented by a user interface of the operating system. It should be noted that the user gesture can be a single user gesture. In this regard, no additional user gestures are required to access the OS menu 220, and the user does not need to interact with any other menus to access the OS menu 220. While interacting with the processing system 100, a user, however, may provide other user gestures unrelated to accessing the OS menu 220.

The OS menu 220 can include various menu items a user may select to initiate various processes related to the application 115. In some cases, more than one application may be currently executing on the processing system 100. When the OS menu 220 is accessed, the OS menu 220 can present menu items pertaining to the application 115 with which the user currently is interacting, or the application 115 that currently has focus in the software environment provided by the operating system. For example, the menu items can pertain to the application 115 presented on a highest layer in the operating system's user interface, pertain to the application 115 with which the user is interacting or most recently has been interacting, or pertain to the application 115 most recently launched by the user.

Execution of the application 115 need not be terminated when the OS menu 220 is presented. For example, the user interface of the application 115 can be minimized or the OS menu 220 can be presented in a user interface pane presented over the user interface of the application 115. Because execution of the application 115 is not terminated, and the OS menu 220 is provided at the operating system level, presentation of the OS menu 220 need not affect operation of the application 115. Moreover, presentation of the OS menu 220 need not affect any data entered into, being presented by, or being processed by the application 115. Thus, when the user returns back to the application 115, the context of the application 115 will remain as it was prior to the OS menu 220 being accessed. There are some exceptions, however. For example, if the user chooses from the OS menu 220 to uninstall the application 115 or to clear application data, then in such cases the application 115 will not remain as it was prior to the OS menu 220 being accessed.

FIG. 3 is an example of the OS menu 220. The OS menu 220 can present a plurality of menu items 325, 330, 335, 340, 345, 350. When any of such menu items 325-350 are selected via a user gesture, the processing system 100 can initiate corresponding operations for an application 115 that currently is executing and has focus in the software environment. As noted, such operations can correspond to operations related to an online store and/or can be related to management of the currently executing application 115. Responsive to the user selecting a menu item 325-350 using a user gesture, the processing system 100 (e.g., the operating system) can initiate corresponding operations.

Menu items corresponding to operations related the online store can include, for example, the menu items 325-330. The menu item 325 can be selected by the user to find other applications related to the currently executing application 115, for example other applications available from an online store. In illustration, responsive to a user selecting the menu item 325, the processing system 100 (e.g., using the operating system) can establish a user session with the online store. By way of example, the processing system 100 can open a web browser or an online store application configured to access the online store. The online store can be an online store from which the application 115 was downloaded when the application 115 was installed on the processing system 100. For instance, the processing system 100 can access a uniform resource identifier (URI), for example a uniform resource locator (URL), from memory (e.g., from a buffer) of the processing system 100, and enter the URI into the web browser or online store application to access the web page. The web browser or online store application can be presented, on the display 105, on a user interface pane above the application 115 and/or above the OS menu 220. Via the web browser or online store application, the processing system 100 can query the online store to identify other applications related to the currently executing application 115, and present a listing of such other applications to the user. Such other applications can be, for example, other applications that perform much of the same functionality of the currently executing application 115 (e.g., other applications that may be used in place of the currently executing application 115), other applications that enhance a user experience using the currently executing application, or the like. From the presented listing, the user can review the other applications and, if the user so desires, choose to download and install any such related applications on the processing system 100. The user can close the web browser or an online store application at any time to return to the OS menu 220 or to return to the application 115.

The menu item 330 can be selected by the user to initiate creation of an electronic message via which the user may send feedback related to the currently executing application. In one arrangement, responsive to a user selecting the menu item 330, the processing system 100 (e.g., using the operating system) can automatically create an electronic message, for example an email or text message. In one arrangement, the processing system 100 can launch an email or text messaging client to create the electronic message. The processing system 100 can access an identifier indicating the currently executing application 115, and an address associated with the online store where feedback is to be sent, from memory of the processing system 100. In this regard, the identifier and address can be retrieved from a buffer. Accordingly, the identifier and address are not provided by the user. Instead, the identifier and address are automatically identified by the processing system responsive to the application 115 being executed. In a subject field of the electronic message, the processing system 100 can automatically insert the identifier that indicates the currently executing application 115. In a recipient field, the processing system 100 can automatically insert the address associated with the online store where feedback is to be sent. The address can be, for example, an email address or a text messaging address. The user can enter feedback (e.g., comments, etc.) regarding the application 115 in a body of the electronic message. When the user is desires to have the electronic message sent, the user can select a “send” icon or button. In response, the processing system 100 can send to the online store the electronic message including the user feedback.

In another arrangement, responsive to a user selecting the menu item 330, the processing system 100 can, via the web browser or online store application, open a web page of the online store configured to receive user feedback. The online store can be an online store from which the application 115 was downloaded when the application 115 was installed on the processing system 100. For example, the processing system 100 can access a URI from memory (e.g., from the buffer) of the processing system 100, and enter the URI into the web browser or online store application to access the web page. Further, the processing system can access the identifier indicating the currently executing application 115 from the memory and, in a subject field presented on the web page, automatically insert the identifier that indicates the currently executing application 115. The web page can present to the user a feedback field in which the user can enter user feedback regarding the application 115, and the user can enter feedback into the feedback field. Optionally, the user can answer any questions asked on the web page, participate in a survey presented on the web page, etc. The user can select a control, for example a “submit” button or icon, on the web page to submit the user's feedback to the online store.

Menu items corresponding to management of the currently executing application 115 can include, for example, the menu items 335-350. The menu item 335 can be selected by the user to uninstall the currently executing application 115. For example, responsive to the user selecting the menu item 335, the processing system 100 (e.g., using the operating system) can close the currently executing application 115 and uninstall the currently executing application 115. In one aspect, the processing system 100 also can clear (i.e. delete) all files and/or data related to and/or used by the application 115. In another aspect, the processing system can prompt the user to choose whether to save certain data used by the application 115, for example user data, files generated by the user using the application, data generated by the user's use of the application, etc. In illustration, the processing system 100 can present a message, on the display 105, prompting the user to choose whether to delete all data or to save certain data. If the user chooses to delete all data, the processing system 100 can delete all of the data. If the user chooses to save certain data, the processing system 100 can save that data, while still uninstalling the application 115.

In one arrangement, prior to initiating operations to uninstall the application 115, the processing system 100 can prompt the user to confirm whether the user wishes to continue. For example, the operating system can present a message, on the display 105, indicating that the user has selected to uninstall the currently executing application 115 and prompting the user to enter a corresponding user gesture (e.g., select a “continue” button) to continue or enter a corresponding user gesture (e.g., select a “cancel” button) to cancel the operation. Responsive to the user choosing to continue, the message and OS menu 220 can be closed and processes corresponding to the selected menu item 335 can be initiated. Responsive to the user choosing to cancel, the message can be closed and, optionally, the OS menu 220 also can be closed.

The menu item 340 can be selected by the user to clear data related to the currently executing application 115. Responsive to the user selecting the menu item 340, the processing system 100 (e.g., using the operating system) can delete from memory of the processing system 100 data related to the application 115. The data can be cleared from bulk storage devices and/or local memory. For example, the processing system can clear user data used by the application 115, clear configuration data used by the application 115, or clear other data stored and/or used by the application 115. In one arrangement, prior to initiating such operations, the processing system 100 can prompt the user to confirm whether the user wishes to continue. For example, the operating system can present a message, on the display 105, indicating that the user has selected to clear the application data and prompting the user to enter a corresponding user gesture (e.g., select a “continue” button) to continue or enter a corresponding user gesture (e.g., select a “cancel” button) to cancel the operation. Responsive to the user choosing to continue, the message and OS menu 220 can be closed and processes corresponding to the selected menu item 340 can be initiated. Responsive to the user choosing to cancel, the message can be closed and, optionally, the OS menu 220 also can be closed.

The menu item 345 can be selected by the user to present details related to the currently executing application's use of data storage. For example, responsive to the user selecting the menu item 345, the processing system 100 (e.g., using the operating system), can present to the user, on the display 105, a message indicating the amount of data storage being used by the application 115. For example, the message can indicate the amount of data storage in a bulk storage device that is being used by the application 115 and/or an amount of data storage in local memory being used by the application 115. The user can enter a user gesture to close the message to return to the OS menu 220 or to return to the application 115.

The menu item 350 can be selected by the user to present information related to permissions assigned to the currently executing application 115. For example, responsive to the user selecting the menu item 345, the processing system 100 (e.g., using the operating system), can present to the user, on the display 105, a message indicating user permissions assigned to the application 115, permissions granted to the application 115 to access data on the processing system 100, access one or more networks, access data provided across one or more networks, access websites, and the like. The user can enter a user gesture to close the message to return to the OS menu 220 or to return to the application 115.

A menu item 355 also can be presented to close the OS menu 220 without performing any further operations. In response to the menu item 355 being selected, the processing system 100 can close the OS menu 220, and the user interface of the currently executing application 115 can be presented on the display 105.

As noted, any number of applications can be installed on, and executed by, the processing device. The user can select any one of the applications in a suitable manner to change focus to such application 115, and then provide the user gesture to present the OS menu 220. Accordingly, the menu items 325-350 will pertain to that application that currently is executing and has focus. The user can select any of the menu items 325-350 to initiate operations related to that application 115. If the user selects another application to shift focus to that application, the menu items 325-350 will pertain to the newly selected application, and the user can select any of the menu items 325-350 to initiate operations related to the newly selected application. In one arrangement, the user may close the OS menu 220 before selecting another application, but the present arrangements are not limited in this regard. For example, the user may select another application (with or without minimizing the OS menu 220) to change focus to that application, and then again access the OS menu 220. In such case, the menu items 325-350 can pertain to the newly selected application that has focus, even though the OS menu 220 may not have been closed and reinitiated. If the OS menu 220 has been closed, the user need only provide a suitable user gesture to again activate the OS menu 220 and have the menu items in the OS menu 220 pertain to the application that has focus in the software environment provided by the operating system.

In a further arrangement in which multiple applications 115 currently are executing on the processing system 100, the OS menu 220 can include a list (not shown) of respective menu items representing each of the currently executing applications 115. In one aspect, the list also can indicate other recently used applications 115. From that list, the user can select one or more of the applications 115. The menu items 325-355 presented in the OS menu 220 can be associated with the selected application(s) 115. For example, if the user selects two or more applications 115, then selects the menu item 325, other applications related to each of the selected applications 115 can be presented to the user. If the user selects two or more applications 115, then selects the menu item 335, each of the selected applications 115 can be uninstalled. Similarly, if the user selects two or more applications 115, then selects the menu item 340, data related to the selected applications 115 can be cleared.

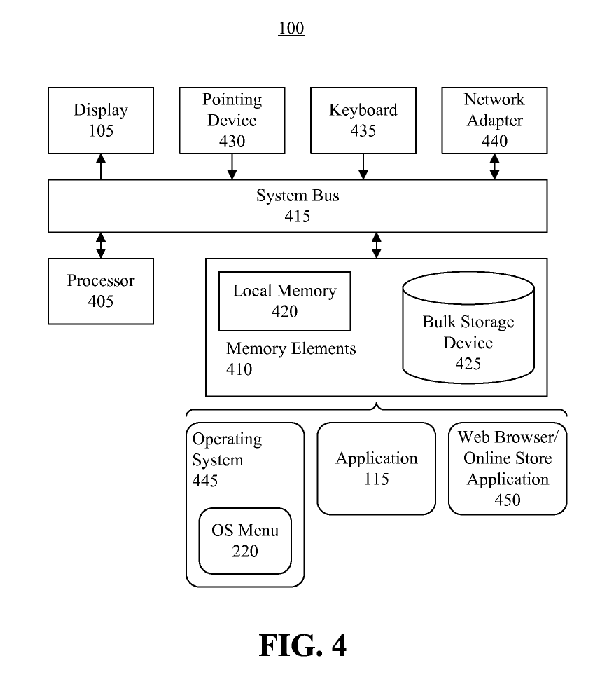

FIG. 4 is a block diagram illustrating example architecture for the processing system 100. The processing system 100 can include at least one processor 405 coupled to memory elements 410 through a system bus 415 or other suitable circuitry. As such, the processing system 100 can store program code within the memory elements 410. The processor 405 can execute the program code accessed from the memory elements 410 via the system bus 415. It should be appreciated that the processing system 100 can be implemented in the form of any system including a processor and memory that is capable of performing the functions and/or operations described within this specification.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), flash memory or other persistent data storage device. The processing system 100 also can include one or more cache memories (not shown) that provide temporary storage of at least some program code in order to reduce the number of times program code must be retrieved from the bulk storage device 425 during execution.

Input/output (I/O) devices such as the display 105 and, optionally, a pointing device 430 and/or a keyboard 435 can be coupled to the processing system 100. The I/O devices can be coupled to the processing system 100 either directly or through intervening I/O controllers. For example, the display 105 can be coupled to the processing system 100 via a graphics processing unit (GPU), which may be a component of the processor 405 or a discrete device. One or more network adapters 440 also can be coupled to processing system 100 to enable the processing system 100 to become coupled to other systems, computer systems, remote printers, and/or remote storage devices through intervening private or public networks. Modems, cable modems, transceivers, and Ethernet cards/adapters are examples of different types of network adapters 440 that can be used with the processing system 100.

As pictured in FIG. 4, the memory elements 410 can store the components of the processing system 100, namely an operating system 445 which presents the OS menu 220 and performs other processes described herein, the application 115 and a web browser and/or online store application 450. The memory elements 410 also can store any number of other applications, services and the like. Being implemented in the form of executable program code, these components of the processing system 100 can be executed by the processing system 100 and, as such, can be considered part of the processing system 100. Moreover, the operating system 445, OS menu 220, application 115 and web browser/online store application 450 each are functional data structures that impart functionality when employed as part of the processing system 100.

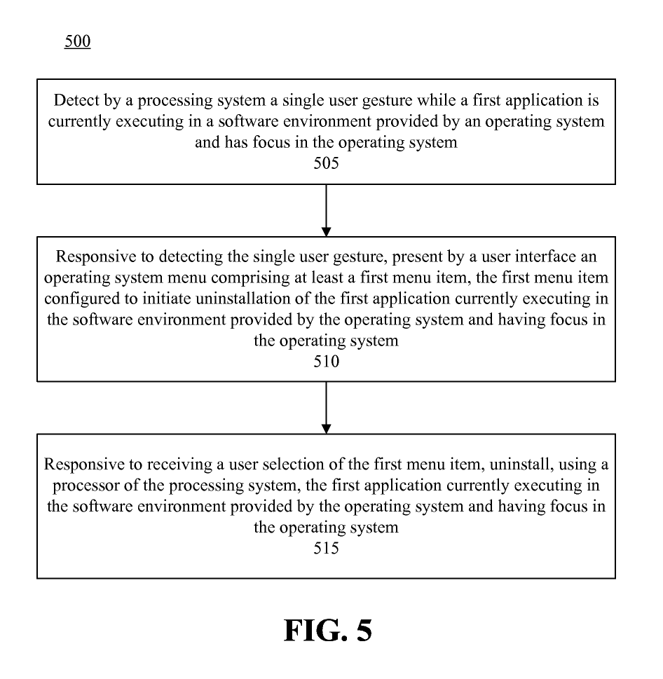

FIG. 5 is a flow chart illustrating an example of a method 500 of uninstalling an application currently executing on a processing system. At step 505, a single user gesture can be detected by a processing system while a first application is currently executing in a software environment provided by an operating system and has focus in the software environment provided by the operating system. At step 510, responsive to detecting the single user gesture, an operating system menu can be presented by a user interface. The operating system menu can include at least a first menu item. The first menu item can be configured to initiate uninstallation of the first application currently executing in the software environment provided by the operating system and having focus in the software environment. At step 515, responsive to receiving a user selection of the first menu item, the first application currently executing in the software environment provided by the operating system and having focus in the operating system can be uninstalled using a processor of the processing system.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting by a processing system a single user gesture while a first application is currently executing in a software environment provided by an operating system and has focus in the operating system;
responsive to detecting the single user gesture, presenting by a user interface an operating system menu comprising at least a first menu item, the first menu item configured to initiate uninstallation of the first application currently executing in the software environment provided by the operating system and having focus in the operating system; and
responsive to receiving a user selection of the first menu item, uninstalling, using a processor of the processing system, the first application currently executing in the software environment provided by the operating system and having focus in the operating system.

2. The method of claim 1, wherein the operating system menu comprises a second menu item, the second menu item configured to initiate a process of finding other applications related to the first application, the method further comprising:
responsive to a user selection of the second menu item, querying an online store to identify other applications related to the first application and presenting a list of the other applications to the user, each of the other applications being user selectable from the list to initiate download and installation of the selected other application.

3. The method of claim 1, wherein the operating system menu comprises a second menu item, the second menu item configured to initiate a process of sending user feedback related to the first application, the method further comprising:
responsive to the first application being executed, temporarily storing in a buffer an identifier indicating the first application currently executing in the software environment provided by the operating system and an address associated with an online store where the user feedback is to be sent; and
responsive to a user selection of the second menu item:
automatically creating, by the processing system, an electronic message;
automatically retrieving from the buffer, and inserting into a subject field of the electronic message, the identifier indicating the first application currently executing in the software environment provided by the operating system; and
automatically retrieving from the buffer, and inserting into a recipient field of the electronic message, the address associated with the online store where the user feedback is to be sent.

4. The method of claim 1, wherein the operating system menu comprises a second menu item, the second menu item configured to initiate a process of sending user feedback related to the first application, the method further comprising:
responsive to the first application being executed, temporarily storing in a buffer an identifier indicating the first application currently executing in the software environment provided by the operating system; and
responsive to a user selection of the second menu item:
automatically accessing a web page of an online store;
automatically retrieving from the buffer, and inserting into a subject field presented on the web page, the identifier indicating the first application currently executing in the software environment provided by the operating system.

5. The method of claim 1, wherein the operating system menu comprises a second menu item, the second menu item configured to initiate a process of presenting to a user a message indicating an amount of data storage being used by the first application, the method further comprising:
responsive to a user selection of the second menu item, presenting to the user the message indicating the amount of data storage being used by the first application.

6. The method of claim 1, wherein the operating system menu comprises a second menu item, the second menu item configured to initiate a process of presenting to a user a message indicating information related to permissions assigned to the first application, the method further comprising:
responsive to a user selection of the second menu item, presenting to the user the message indicating information related to permissions assigned to the first application.

7. The method of claim 1, wherein the operating system menu comprises a second menu item, the second menu item configured to initiate a process of clearing data related to a second application currently executing in the software environment provided by the operating system, the method further comprising:
responsive to a user selection of the second menu item, clearing data related to the second application from memory of the processing system, wherein the second application currently has focus on the processing system when the second menu item is selected by the user.

8. A processing system, comprising:
a processor programmed to initiate executable operations comprising:
detecting a single user gesture while a first application is currently executing in a software environment provided by an operating system and has focus in the operating system;
responsive to detecting the single user gesture, presenting by a user interface an operating system menu comprising at least a first menu item, the first menu item configured to initiate uninstallation of the first application currently executing in the software environment provided by the operating system and having focus in the operating system; and
responsive to receiving a user selection of the first menu item, uninstalling the first application currently executing in the software environment provided by the operating system and having focus in the operating system.

9. The processing system of claim 8, wherein the operating system menu comprises a second menu item, the second menu item configured to initiate a process of finding other applications related to the first application, the executable operations further comprising:
responsive to a user selection of the second menu item, querying an online store to identify other applications related to the first application and presenting a list of the other applications to the user, each of the other applications being user selectable from the list to initiate download and installation of the selected other application.

10. The processing system of claim 8, wherein the operating system menu comprises a second menu item, the second menu item configured to initiate a process of sending user feedback related to the first application, the executable operations further comprising:
responsive to the first application being executed, temporarily storing in a buffer an identifier indicating the first application currently executing in the software environment provided by the operating system and an address associated with an online store where the user feedback is to be sent; and
responsive to a user selection of the second menu item:
automatically creating an electronic message;
automatically retrieving from the buffer, and inserting into a subject field of the electronic message, the identifier indicating the first application currently executing in the software environment provided by the operating system; and
automatically retrieving from the buffer, and inserting into a recipient field of the electronic message, the address associated with the online store where the user feedback is to be sent.

11. The processing system of claim 8, wherein the operating system menu comprises a second menu item, the second menu item configured to initiate a process of sending user feedback related to the first application, the executable operations further comprising:
responsive to the first application being executed, temporarily storing in a buffer an identifier indicating the first application currently executing in the software environment provided by the operating system; and
responsive to a user selection of the second menu item:
automatically accessing a web page of an online store;
automatically retrieving from the buffer, and inserting into a subject field presented on the web page, the identifier indicating the first application currently executing in the software environment provided by the operating system.

12. The processing system of claim 8, wherein the operating system menu comprises a second menu item, the second menu item configured to initiate a process of presenting to a user a message indicating an amount of data storage being used by the first application, the executable operations further comprising:
responsive to a user selection of the second menu item, presenting to the user the message indicating the amount of data storage being used by the first application.

13. The processing system of claim 8, wherein the operating system menu comprises a second menu item, the second menu item configured to initiate a process of presenting to a user a message indicating information related to permissions assigned to the first application, the executable operations further comprising:
responsive to a user selection of the second menu item, presenting to the user the message indicating information related to permissions assigned to the first application.

14. The processing system of claim 8, wherein the operating system menu comprises a second menu item, the second menu item configured to initiate a process of clearing data related to a second application currently executing in the software environment provided by the operating system, the executable operations further comprising:
responsive to a user selection of the second menu item, clearing data related to the second application from memory of the processing system, wherein the second application currently has focus on the processing system when the second menu item is selected by the user.

15. A computer program product comprising a computer readable storage medium having program code stored thereon, the program code executable by a processor to perform a method comprising:
detecting, by the processor, a single user gesture while a first application is currently executing in a software environment provided by an operating system and has focus in the operating system;
responsive to detecting the single user gesture, presenting by a user interface an operating system menu comprising at least a first menu item, the first menu item configured to initiate uninstallation of the first application currently executing in the software environment provided by the operating system and having focus in the operating system; and
responsive to receiving a user selection of the first menu item, uninstalling, by the processor, the first application currently executing in the software environment provided by the operating system and having focus in the operating system.

16. The computer program product of claim 15, wherein the operating system menu comprises a second menu item, the second menu item configured to initiate a process of finding other applications related to the first application, the method further comprising:
responsive to a user selection of the second menu item, querying an online store to identify other applications related to the first application and presenting a list of the other applications to the user, each of the other applications being user selectable from the list to initiate download and installation of the selected other application.

17. The computer program product of claim 15, wherein the operating system menu comprises a second menu item, the second menu item configured to initiate a process of sending user feedback related to the first application, the method further comprising:
responsive to the first application being executed, temporarily storing in a buffer an identifier indicating the first application currently executing in the software environment provided by the operating system and an address associated with an online store where the user feedback is to be sent; and
responsive to a user selection of the second menu item:
automatically creating, by the processor, an electronic message;
automatically retrieving from the buffer, and inserting into a subject field of the electronic message, the identifier indicating the first application currently executing in the software environment provided by the operating system; and
automatically retrieving from the buffer, and inserting into a recipient field of the electronic message, the address associated with the online store where the user feedback is to be sent.

18. The computer program product of claim 15, wherein the operating system menu comprises a second menu item, the second menu item configured to initiate a process of sending user feedback related to the first application, the method further comprising:
responsive to the first application being executed, temporarily storing in a buffer an identifier indicating the first application currently executing in the software environment provided by the operating system; and
responsive to a user selection of the second menu item:
automatically accessing a web page of an online store;
automatically retrieving from the buffer, and inserting into a subject field presented on the web page, the identifier indicating the first application currently executing in the software environment provided by the operating system.

19. The computer program product of claim 15, wherein the operating system menu comprises a second menu item, the second menu item configured to initiate a process of presenting to a user a message indicating an amount of data storage being used by the first application, the method further comprising:
responsive to a user selection of the second menu item, presenting to the user the message indicating the amount of data storage being used by the first application.

20. The computer program product of claim 15, wherein the operating system menu comprises a second menu item, the second menu item configured to initiate a process of presenting to a user a message indicating information related to permissions assigned to the first application, the method further comprising:
responsive to a user selection of the second menu item, presenting to the user the message indicating information related to permissions assigned to the first application.
